(19) United States
(12) Patent Application Publication
(10) Pub. No.: US 2004/0089695 A1
(43) Pub. Date: May 13, 2004

(54) Working station

(76) Inventor: Ake Svensson, Falkenberg (SE)

Correspondence Address: MCGINN & GIBB, PLLC, 8321 OLD COURTHOUSE ROAD, SUITE 200, VIENNA, VA, 22182-3817, US

(21) Appl. No.: 10/450,510

(22) PCT Filed: Dec. 14, 2001
(86) PCT No.: PCT/SE01/02790

(30) Foreign Application Priority Data
Dec. 15, 2000 (SE) 0004654-0

(51) Int. Cl. B25C 5/00

(52) U.S. Cl. 227/99; 227/110

(57) ABSTRACT

The present invention relates to a device for executing a number of actions, e.g. driving in nails, on a planar section, e.g. a wall element, for fixing a covering panel or the like on the planar section, which comprises a number of action devices which are displaceable over the covering panel transversely and longitudinally thereof, a number of the action devices (16-19) being mounted on one side of a carriage, a number of the action devices (21-24) being mounted on the other side of the carriage, and the action devices (16-19, 21-24) being displaceable individually and/or together with one another along the carriage, and the carriage and/or the covering panel being displaceable in relation to the other.

The present invention relates to a device according to the preamble to appended claim 1.

Prior art devices of the type disclosed by way of introduction have a complicated design and construction which has a severe effect on the possibility of utilising the device in modern contexts with high requirements of versatility and above all rapidity. A further drawback resides in the fact that prior art constructions require extensive maintenance and, as a result, lengthy down times.

The task forming the basis of the present invention is to realise an improved device and to obviate or at least reduce the above-outlined drawbacks.

This task is solved according to the present invention in that the device indicated by way of introduction is given the characterising features as set forth in appended claim 1.

The present invention realises a device displaying an extremely high degree of versatility and simple construction. The device according to the present invention makes for the execution of a considerable number of work or action phases with a high degree of rapidity in that, int. al. the requisite displacement distances and displacement phases become considerably shorter than in prior art devices.

One embodiment of a device according to the present invention will be described in greater detail hereinbelow, with reference to the accompanying drawings.

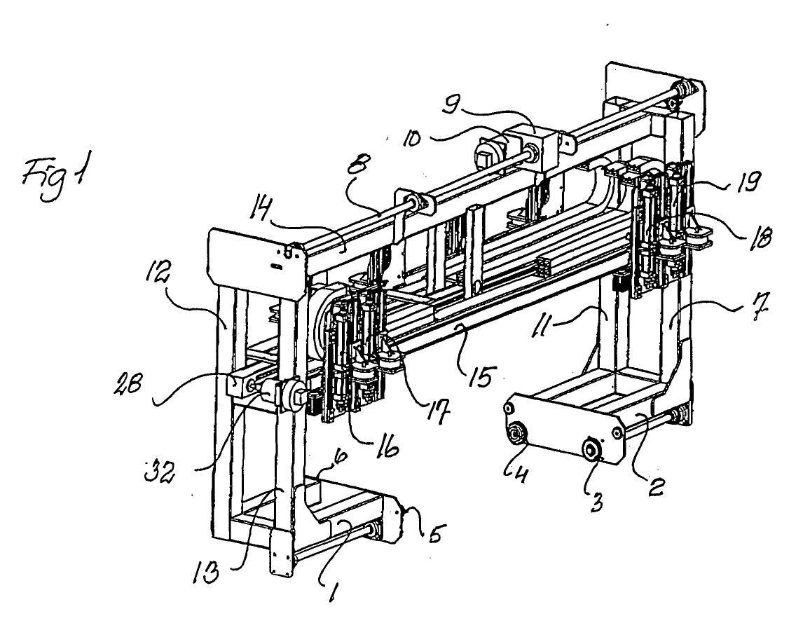

FIG. 1 is a perspective view of one embodiment of a device according to the present invention.

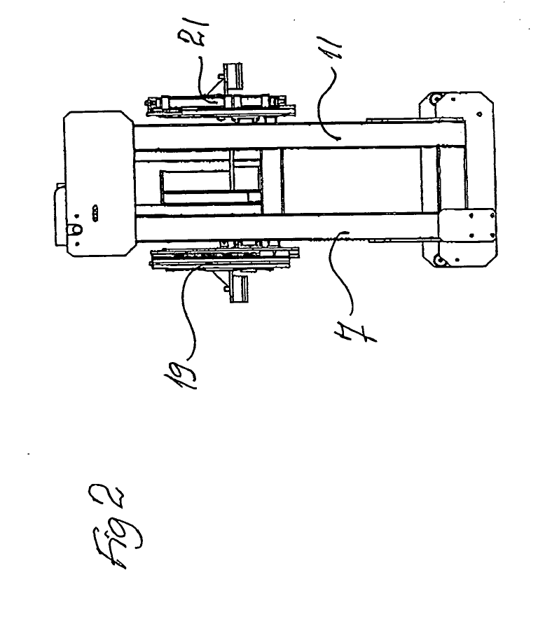

FIG. 2 is a side elevation of the device of FIG. 1.

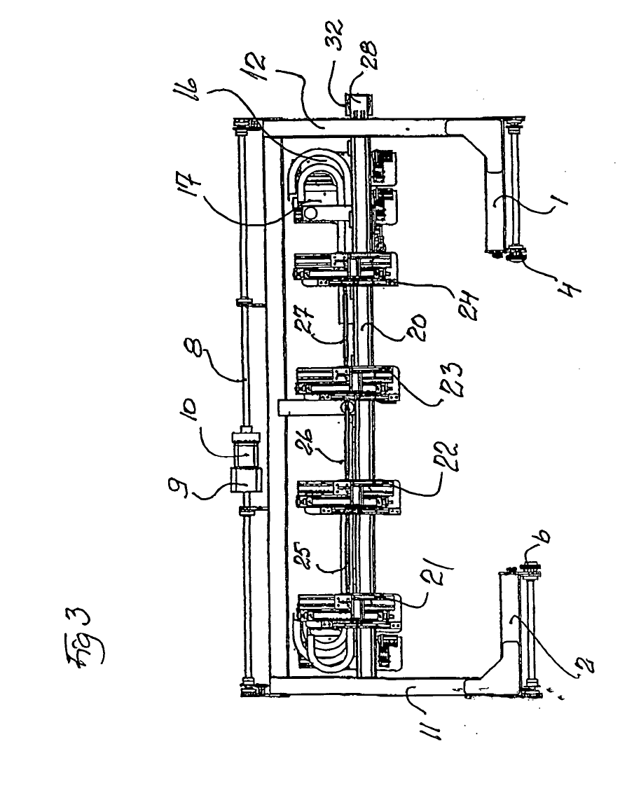

FIG. 3 is a front elevation of the device of FIGS. 1 and 2.

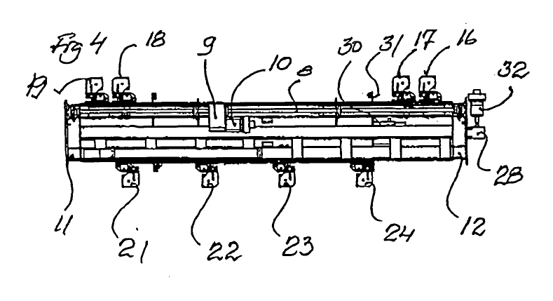

FIG. 4 shows, on a slightly smaller scale, a top plan view of the device of FIGS. 1-3.

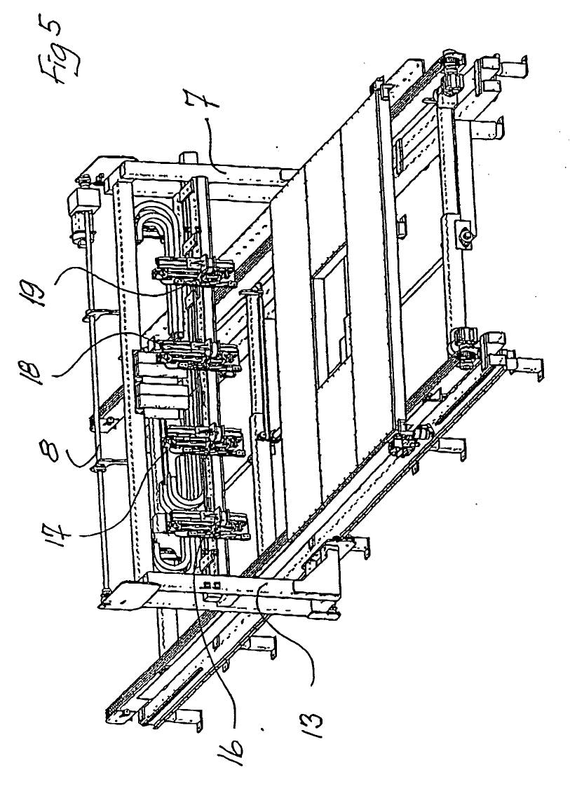

FIG. 5 is a photographic illustration of a device according to the present invention for exemplifying the processing of a wall element.

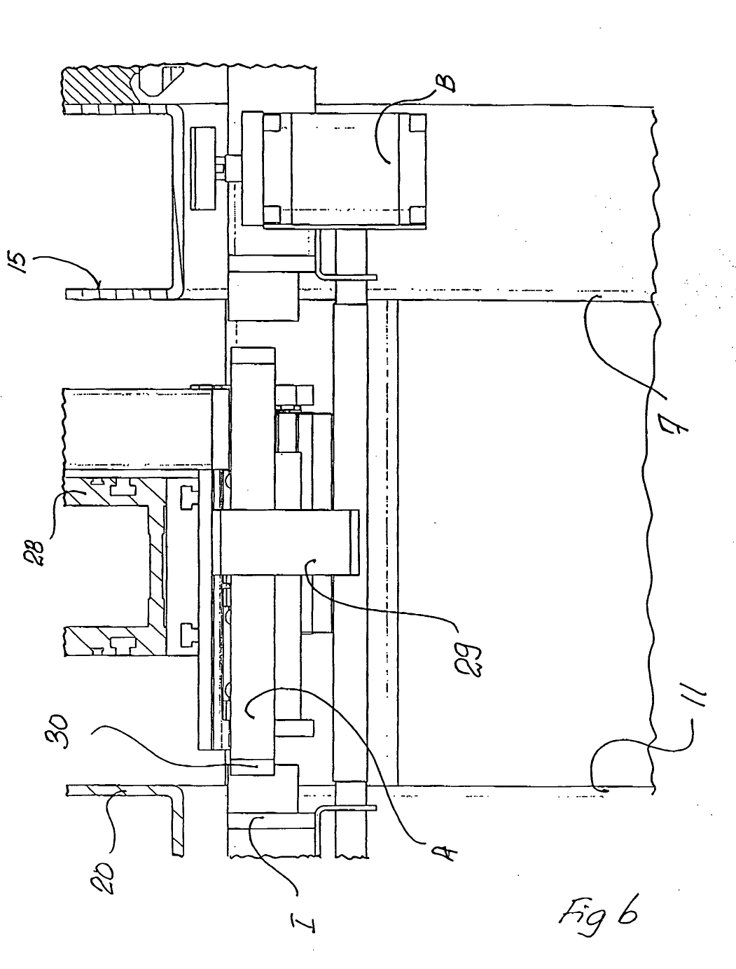

FIG. 6 is a photographic illustration of parts of the device in FIG. 5.

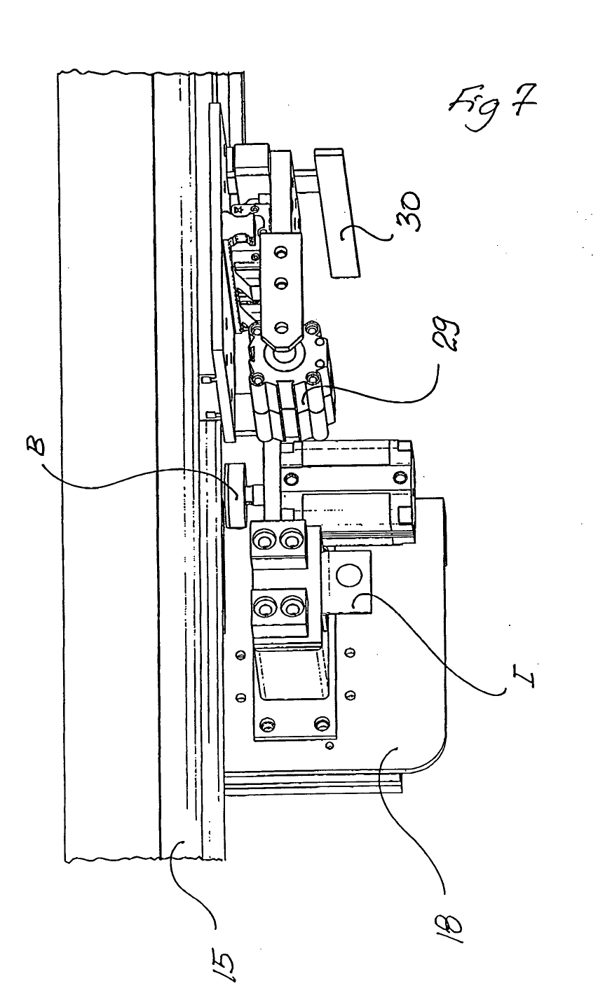

FIG. 7 is a photographic illustration of substantially the same parts as in FIG. 6 in another direction.

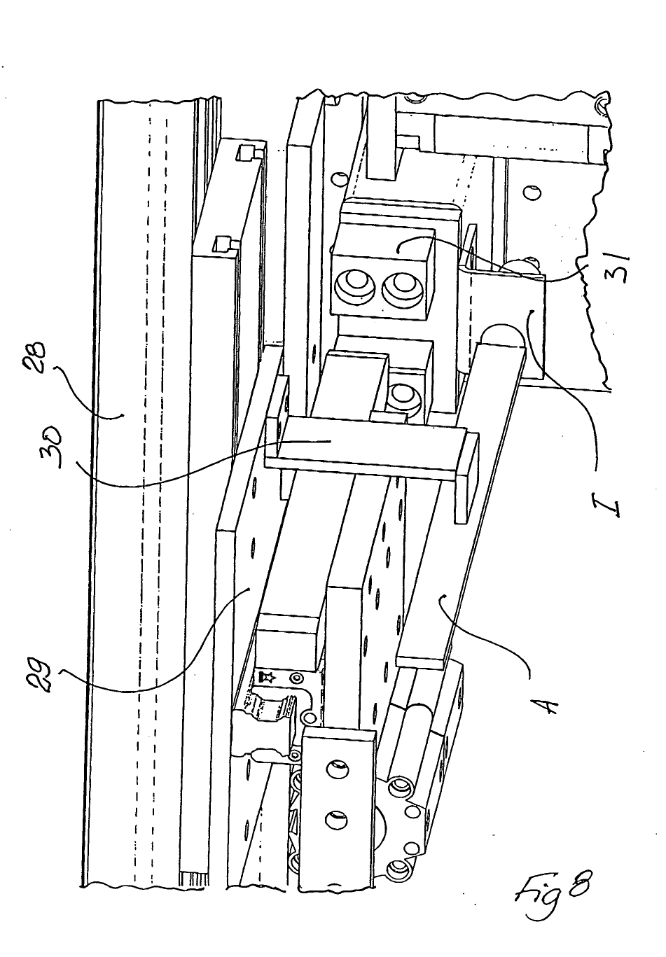

FIG. 8 is a photographic illusion of parts of the device in another direction than in FIG. 7.

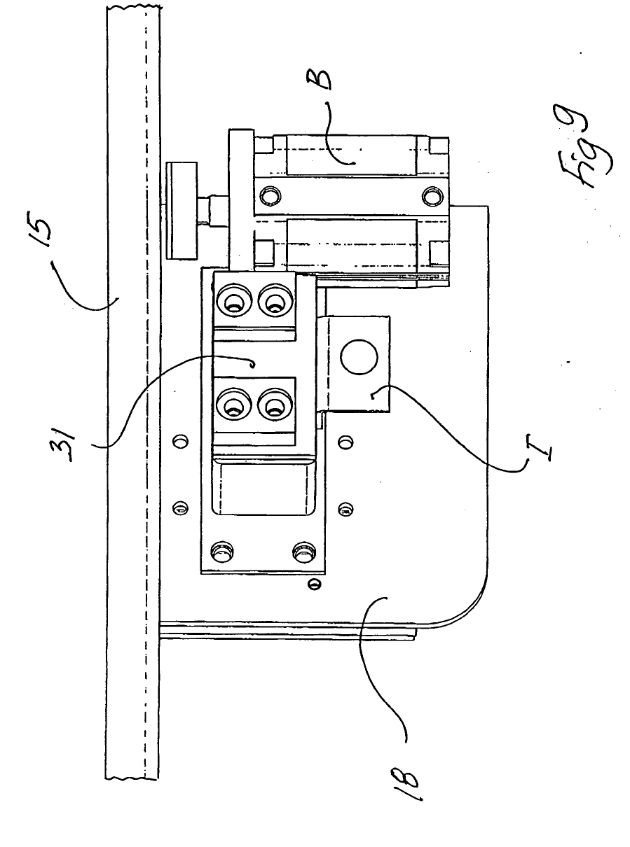

FIG. 9 is a photographic illustration of parts of the device in yet another direction.

The embodiment of the present invention illustrated on the drawings will be described in greater detail below in connection with its use for nailing covering panel, e.g. plywood, on a wall section which consists of ground plate, top plate and a number of joists extending therebetween, these part being nailed together in a different machine. The latticework is placed on a substrate and the covering panel is placed above the latticework and is to be fixedly nailed thereon for the formation of a wall section as is illustrated in FIG. 5. The latticework or wall section which, in this case, has a door opening and a window opening, is fixed on a substrate which has runway on either side. The device according to the present invention has, as is shown on the drawings, the form of a gantry with a left foot 1 and a right foot 2. The feet 1 and 2 are provided with wheels 3, 4, 5 and 6, of which a number of wheels are not apparent in FIG. 1. The wheels 3-6 are intended to run on the runaways or rails which extend under the substrate on which the latticework with the covering panel rests and is fixed. A number of the wheels 4-6 are driven for movement of the carriage or gantry along the rails. The wheels 3-6 are driven by means of a chain which extends through one of the legs 7 of the carriage or gantry. The chain extends around a gear chain wheel at the end of a shaft 8 which extends to the opposite end of the carriage or gantry and through a prime mover in the form of a gearbox 9 and a motor 10.

The carriage or gantry has one leg at each corner. In addition to the leg 7, there are thus legs 11, 12 and 13. The legs 7, 11, 12 and 13 carry a crosspiece or beam 14 which interconnects the legs 7, 11, 12 and 13 with each other and supports the drive means 9, 10 and the shaft 8.

A beam 15 extends between the legs 7 and 13 and carries four nail guns 16, 17, 18, 19. The nail guns 16-19 are reciprocally movable on the beam 15 both individually and mutually. Between the legs 11 and 12, there is disposed an additional beam 20 for a further four nail guns 21, 22, 23 and 24. The nail guns 21 and 22 are interconnected by means of a rod 25, while the nail guns 22 add 23 are interconnected by means of a rod 26 and the nail guns 23 and 24 are interconnected by means of a rod 27. Thus the nail gums 21, 22, 23 and 24 are movable on the beam 20 reciprocally thereon in one unit, with one another, since they are interconnected with one another by means of the rods 25, 26 and 27. The nail guns 16-19 and 21-24 normally consist of pneumatic nailing units with nail band magazines for the automatic driving of nails. Naturally, there is nothing to prevent the use of screw tightening units instead of the nailing units for fixing the covering panel by means of screws instead of nails. It is also possible to employ both nailing units and screw driving units or other unit combinations.

Centrally within the carriage or the gantry and between the legs 7 and 11 and 12 and 13, there is disposed a further beam 28 for a centrally disposed switching unit or displacement unit 29 which is provided with a connection device 30 which, by means of a piston and cylinder assembly K, is switchable from a free position disengaged from any of the units 16-19 or 21-24 to and from engagement with any of the nailing units 16-19 on the one side of the gantry or the mutually interconnected units 21-24 on the other side of the gantry. Thus, there is required only a single engagement between the connection device 30 and a connection female unit 31 with all of the nailing units 21-24, on the one hand, with the aid of an inductive transducer I and an element A co-operating therewith, to find the position of the units and, on the other hand, to displace all units 21-24 to a new position. For switching of the other nailing units 16, 17, 18 and 19, engagement is required with each one of their connection female units 31 and the connection device 30 after switching thereof by means of the piston and cylinder assembly K of the displacement unit 29 and, further, for establishing the position of the unit by means of each one of the units' connection female units 31 and the connection device 30 and also for placing of each respective unit in the desired position.

The switching unit 29 with the connection device 31 and the element A is displaceable on the beam 28 towards and away from the ends of the carriage or gantry by means of a motor 32 which drives a toothed belt inside the beam 28. Naturally, the toothed belt is in engagement with the switching unit 30. The drive motor 32 is mounted on the leg 13.

The nailing units 16-19 and 21-24 are each provided with a brake B, while the nailing units 21-24 are provided with a common brake B. The brakes B are in the form of a cylinder for braking engagement with a braking path on or at each respective beam 15, 20. It is clearly apparent in FIG. 5 that the nailing unit 16-24 are provided with wheels H for cooperation with the covering panel. Those wheels H also serve for realising a substantially uniform nailing depth. It is also possible to carry out many other work phases, e.g. a glue application phase.

Many modifications are naturally possible without departing from the scope of the inventive concept as defined in the appended claims.

1. Device for executing a number of actions, e.g. driving in nails, on a planar section, e.g. a wall element, for fixing a covering panel or the like on the planar section, which includes a number of action devices which are movable over the covering panel transversely and longitudinally thereof and possibly also diagonally, characterised in that a number of the action devices (16-19) are mounted on one side of a carriage, that a number of the action devices (21-24) ate mounted on the other side of the carriage, that the action devices (16-19 and 21-24) are displaceable individually and/or together with one another along the carriage, and that the carriage and/or the covering panel with its substrate is displaceable in relation to the other.

2. The device as claimed in claim 1, characterised in that the action devices on the one side of the carriage (21-24) are interconnected with one another so as to be displaceable together with one another, while the action devices (16-19) on the other side of the carriage are mutually displaceable independently.

3. The device as claimed in any of claims 1 and 2, characterised in that the planar section with the covering panel is fixed on a substrate, and that the carriage with the action devices (16-19 and 21-24) is displaceable reciprocally over the covering panel in a first direction, while the action devices (16-19 and 21-24) are displaceable reciprocally on the carriage in the other direction substantially at right angles to said first direction.

4. The device as claimed in any of the preceding claims, characterised in that a device (30, 31) is disposed for displacement of the action devices (16-19 and 21-24) and is arranged substantially centrally in the carriage between the action devices (16-19 and 21-24) on the one side and the action devices (21-24) on the other side.

5. The device as claimed in claim 4, characterised in that the displacement device (30, 31) has connection means (31) for cooperation with the action devices (16-19) on the one side in a first position and, after switching to a second position, for cooperation with the action devices (21-24) on the other side of the carriage.

6. The device as claimed in claim 5, characterised in that the displacement device (30) is disposed, on the one hand, to establish the position of the action devices (16-19 and 21-24) and thereafter to position the action devices (16-19 and 21-24) to the desired positions, the action devices (21-24) on the one side of the carriage being displaced together and the action devices (16-19) on the other side of the carriage being displaced individually.
